(19) United States
(12) Patent Application Publication
(10) Pub. No.: US 2025/0341452 A1
(43) Pub. Date: Nov. 6, 2025

(54) PORTABLE TENSILE STRENGTH TESTER

(71) Applicant: Hyperform Inc., Rockledge, FL (US)

(72) Inventors: William S. Hayden, Palm Bay, FL (US); Dustin Emanis, Cocoa, FL (US); Patrick Langley, Rockdedge, FL (US)

(21) Appl. No.: 18/791,942

(22) Filed: Aug. 1, 2024

Related U.S. Application Data
(60) Provisional application No. 63/641,640, filed on May 2, 2024.

(51) Int. Cl. G01N 3/24

(52) U.S. Cl. CPC G01N 3/24; G01N 2203/0091; G01N 2203/0244

(57) ABSTRACT

An apparatus for testing adhesive strength between a cover layer and a surface includes a base, a head operably coupled with the base via a slide such that the head is configured to slide with respect to the base, a coupler assembly configured to attach to the cover layer, an actuator configured to drive the coupler assembly vertically upward to separate the cover layer from the surface and to simultaneously slidably move the head along the slide, and a sensor operably coupled to the coupler assembly and configured to measure a pulling force between the coupler assembly and the cover layer.

### CROSS-REFERENCE TO RELATED APPLICATIONS

The present application claims priority to U.S. Provisional Patent Application No. 63/641,640, filed May 2, 2024, entitled “PORTABLE TENSILE STRENGTH TESTER,” the entire disclosure of which is incorporated herein by reference.

### FIELD OF THE DISCLOSURE

The present disclosure generally relates to a portable tensile strength tester and, more particularly, relates to an apparatus for testing tensile strength of material adhered to a target surface.

### BACKGROUND OF THE DISCLOSURE

Cover pads for boat decks are conventionally installed with a pressure-sensitive adhesive (PSA) that forms a bond when pressure is applied. Incorrect installation of the PSA (e.g., not applying pressure equally across portions of the cover pad, not aligning the cover pads with target positions on the boat deck) can result in the bonds not adequately being formed between the cover pad and the boat deck. Incorrect installation can also result in too strong of bonds being formed between the cover pad and the boat deck, thereby resulting in residue or remains (e.g., portions of the cover pad) remaining attached to the boat deck with the cover pad removed. It may be challenging to determine whether installation of the cover pad was correct without invasive testing methods that can require removal of at least part of the boat deck/cover pad assembly for off-site testing. There is a need for testing proper installation on-site that does not result in deconstruction of the boat deck itself.

### SUMMARY OF THE DISCLOSURE

According to one aspect, an apparatus for testing adhesive strength between a cover layer and a surface includes a base, a head operably coupled with the base via a slide such that the head is configured to slide with respect to the base, a coupler assembly configured to attach to the cover layer, and an actuator configured to drive the coupler assembly vertically upward to separate the cover layer from the surface and to simultaneously slidably move the head along the slide.

According to another aspect, an apparatus for testing adhesive strength between a cover layer and a surface includes a base, a head operably coupled with the base via a slide, a coupler assembly configured to attach to the cover layer, an actuator disposed in the head configured to drive the coupler assembly upward to separate the cover layer from the surface and to move the head along the slide, and a pulley system between the base and the coupler assembly, wherein the pulley system is configured to move the head along the slide in response to the actuator driving the coupler upward.

According to yet another aspect, an apparatus for testing adhesive strength between a cover layer and a surface includes a base, a head slidably coupled with the base via a slide, a coupler assembly including a clamp configured to attach to the cover layer, and including a clamp, an actuator configured to drive the coupler assembly upward to separate the cover layer from the surface and to move the head along the slide, a pulley system between the base and the coupler assembly, wherein the pulley system is configured to pull the head along the slide in response to the actuator driving the coupler upward, and a sensor configured to measure a pulling force between the clamp and the cover layer as the head moves along the slide.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of an apparatus for testing adherence between a cover layer and a surface of a watercraft;

FIG. 2 is a perspective view of the apparatus for testing adherence between a cover layer and a surface in a first position;

FIG. 3 is a perspective view of the apparatus for testing adherence between a cover layer and a surface in a second position; and

FIG. 4 is a functional block diagram of an apparatus for testing adherence between a cover layer and a surface.

The components in the figures are not necessarily to scale, emphasis instead being placed upon illustrating the principles described herein.

### DETAILED DESCRIPTION

The present illustrated embodiments reside primarily in combinations of method steps and apparatus components related to a portable tensile strength tester. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

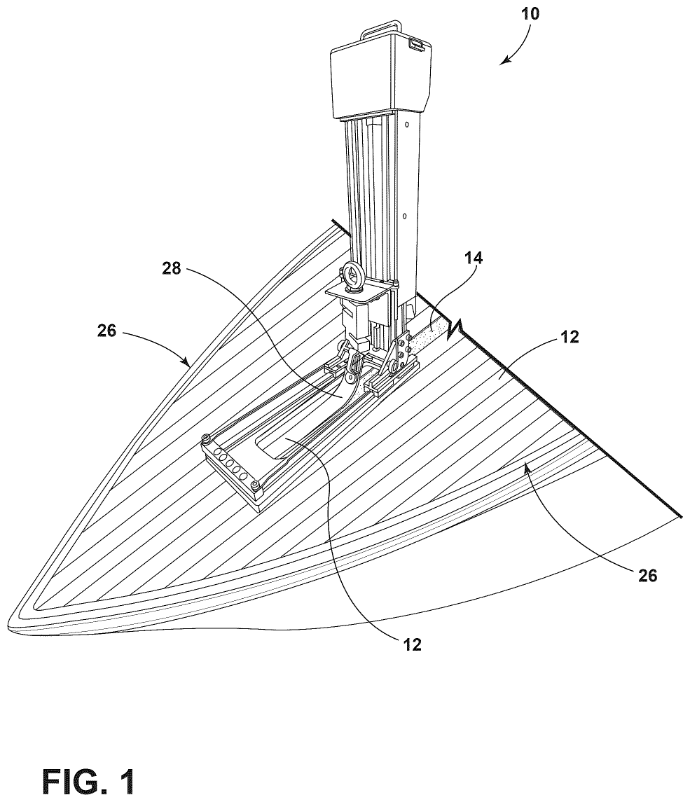

Referring generally to FIGS. 1-3, reference numeral 10 generally designates an apparatus for testing adherence between a cover layer 12 and a surface 14. The apparatus 10 provides a portable way to efficiently and accurately measure the tensile strength of material adhered to a support, such as deck flooring adhered to a floor of a boat. For example, the apparatus 10 can be sized to carry on-site to a boat, placed on the deck flooring, and activated to peel the deck floor from the floor of the boat while measuring the force to peel the deck floor, thereby allowing the apparatus 10 to determine correct or incorrect installation. The apparatus 10 also generally provides for accurate measurements by allowing the peeling process to have consistent measurements as the deck flooring is peeled by providing multiple moving parts. In this way, the apparatus 10 can provide a flexible solution for optimizing tensile strength testing and classification of proper installation of the deck flooring material.

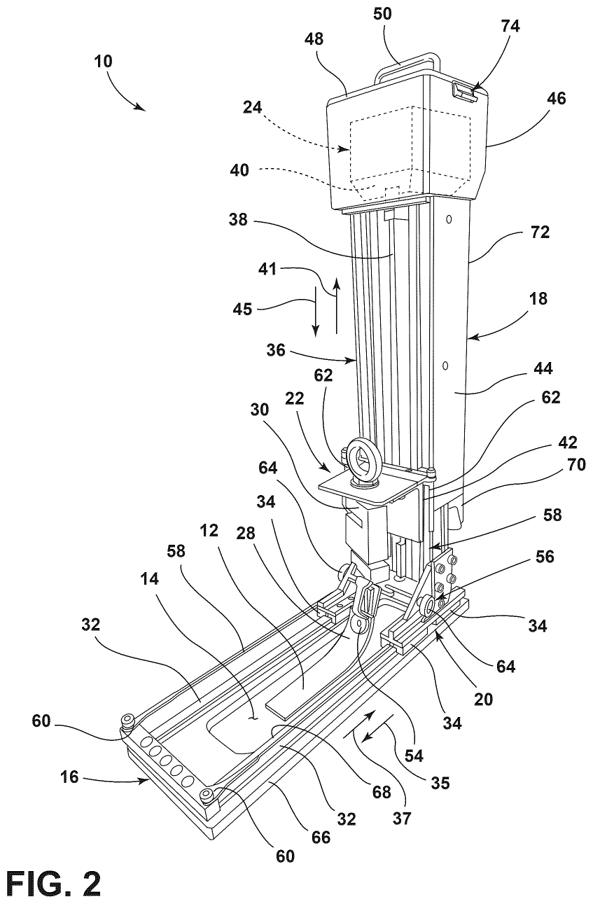

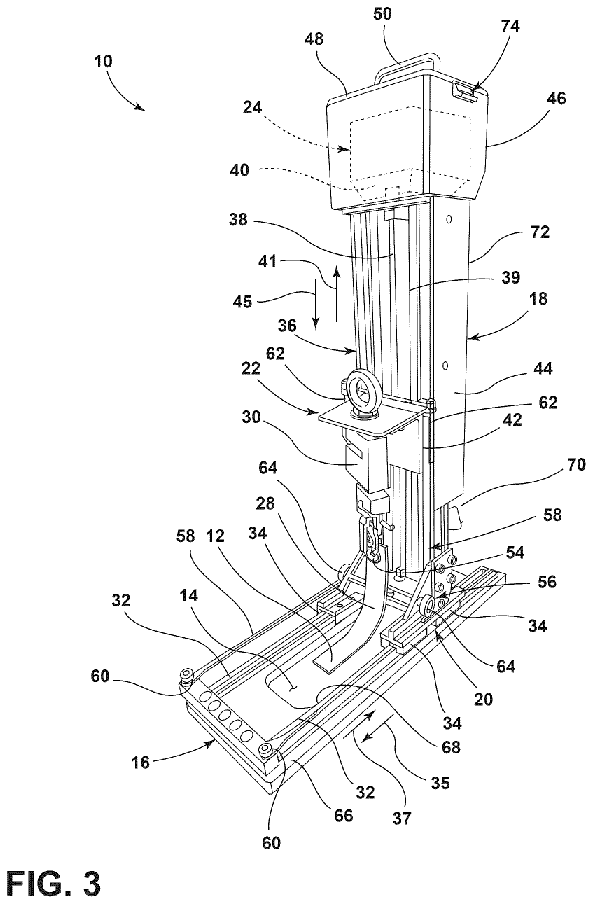

The apparatus 10 includes a base 16 and a head 18 operably coupled with the base 16 via a slide 20. The apparatus 10 includes a coupler assembly 22 configured to attach to the cover layer 12. The apparatus 10 (FIGS. 2-3) includes an actuator 24 disposed in the head 18 configured to drive the coupler assembly 22 upward to separate the cover layer 12 from the surface 14 and to move the head 18 along the slide 20.

With particular reference to FIG. 1, the apparatus 10 can be configured for portable use on a watercraft. The apparatus 10 can be applied to any location on the watercraft having flooring with pressure-sensitive adhesive (PSA). In the present example and as best illustrated in FIG. 1, the watercraft has a body 26 that includes a floor forming the surface 14 on which the cover layer 12 is applied. The cover layer 12 can comprise any type of material, such as ethyl vinyl acetate (EVA) or another foam, rubber, plastic, or any other polymeric or non-polymeric material typically used for applied flooring to the body 26 of the watercraft.

With continued reference to FIG. 1, the apparatus 10 is placed on the cover layer 12 of the watercraft. A strip 28 of the cover layer 12 is initially peeled back slightly from the surface 14 to allow the apparatus 10 to attach with a portion of the cover material. In some examples, the strip 28 of the cover layer 12 is first cut to define an area to be tested by the apparatus 10. For example, two parallel slices can be applied to define a width of the strip 28. The particular width may vary depending on testing conditions, such as the type of material, environmental conditions (e.g., moisture conditions), or minimum widths for standard testing procedures. After the coupling assembly secures to the strip 28, the apparatus 10 can be activated (e.g., the actuator 24 is activated), and the coupler assembly 22 begins to move along the length of the area to be tested while pulling the cover layer 12 from the surface 14.

As the strip 28 is peeled from the surface 14, measurements indicating force, pressure, or another parameter indicative of the tensile strength of the cover layer 12 can be gathered. For example, a sensor 30 (FIGS. 2-4) can be a force gauge having a local display indicating the force (e.g., number of Newtons) required to remove the cover layer 12. This information can be shared, saved, and the like during or following the test.

Referring now to FIGS. 2 and 3, the apparatus 10 is shown in a first position (e.g., the head 18 in an initial position-FIG. 2) and a second position (e.g., the head 18 in a final position-FIG. 3). The slide 20 includes a pair of rails 32 mounted to the base 16 and a corresponding pair of glides 34 coupled to the head 18 that mate with the pair of rails 32 and allow the head 18 to translate along the pair of rails 32 in a forward direction 35 and a rearward direction 37. The head 18 includes a drive assembly 36 that includes the actuator 24 and a screw drive 38. The actuator 24 can include a motor 40 that actuates a drive screw 39 and the screw drive 38 to cause the coupling assembly to move upward in a direction 41 or downward in a direction 43 depending on the rotation direction of the motor 40. For example, the screw drive 38 may further include a ball nut (not shown) coupled to the coupler assembly 22 and operably coupled with the screw 39 to form the screw drive or ball screw actuated by the motor 40. Side plating 44 at least partially surrounds the screw drive 38 to conceal the ball screw. Upper plating 46 conceals the actuator 24.

The screw drive 38 extends along a height of the head 18 in a direction substantially normal to the floor and the base 16. The screw drive 38 may be driven at a top end 48 of the head 18 by the motor 40. A handle 50 is coupled to the top end 48 to allow a user to transport the apparatus 10 by carrying the head 18. To enhance portability, it is contemplated that the base 16 and the head 18 may be decoupled in a transport configuration, though this example is non-limiting, as the apparatus 10 is portable in any configuration (e.g., assembled).

A support plate 42 is movably coupled with the ball screw. A clamp 54 suspends from the support plate 42 via the sensor 30 and is configured to pinch or otherwise secure with a strip 28 of the cover layer 12. The sensor 30 is configured to detect the force required to lift the clamp 54 and thus the force required to peel the strip 28 when the drive assembly 36 drives the support plate 52 in the upward direction 41. It is contemplated that the clamp 54 can include typical or atypical clamping mechanisms. For example, the clamp 54 may include fasteners, magnetic connectors, snap-on buttons, through-hole connectors, or any other feature to secure the coupling assembly with the strip 28.

With continued reference to FIGS. 2 and 3, the apparatus 10 is provided with a pulley system 56 between the base 16 and the coupler assembly 22 and configured to move the head 18 along the slide 20 in the forward direction 37 in response to the actuator 24 driving the coupler assembly 22 in the upward direction 41. The pulley system 56 includes a pair of cables 58 that extend between the base 16 and the head 18 to translate the head 18 along the base 16 in the directions 35, 37 in response to the coupler assembly 22 moving in the directions 41, 43, respectively. More specifically, each of the pair of cables 58 has a first end 60 coupled to the base 16 and a second end 62 coupled to the support plate 12 of the coupler assembly 22. The cables 58 are under tension, such that pulling the strip 28 upward results in sliding the head 18 in the forward direction 35 along the base 12. A pair of pulleys 64 are mounted to the head 18, with each pulley 64 engaging one of the pair of cables 58 between the first and second end 62 to transfer a portion of the pulling force into a lateral pulling force of the head 18. It is contemplated that a wheel, gear, or other transmission device may be used in addition or in an alternative to the pulley system 56 to cause the head 18 to move relative to the base 16.

The base 16 includes a base plate 66 that defines a notch 68 through which the strip 28 extends to couple with the clamp 54. Thus, as the head 18 approaches a full-forward position to overlay a front of the notch 68, the strip 28 is unable to be pulled through the notch 68 and the head 18 is at full stroke. The distance traveled by the head 18 may correspond to an operating distance for the screw drive 38. Accordingly, for a given test, the head 18 can be positioned in a rear position, with a relatively long part of the cables 58 being horizontal relative to the cables 58 in the full-forward position.

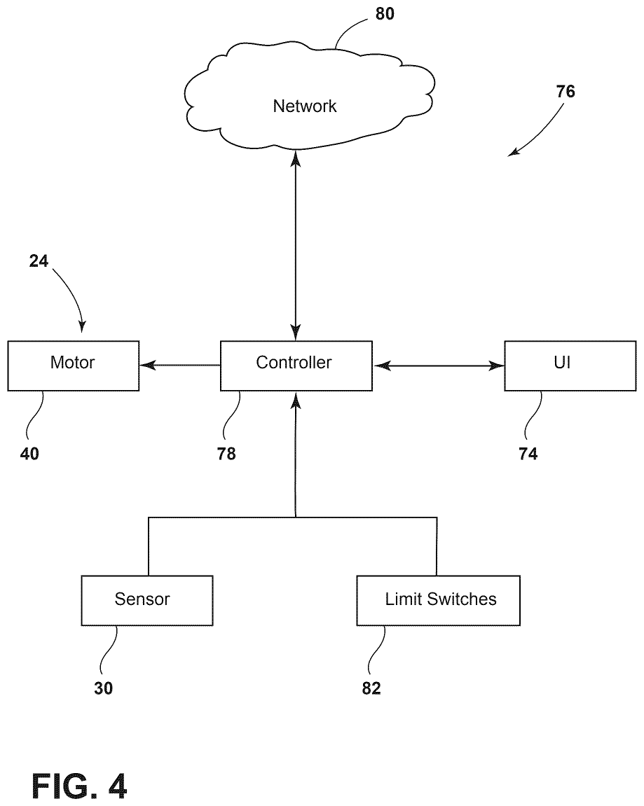

A power source 70, such as an electrochemical cell (e.g., a battery), is provided on the head 18 for powering the actuator 24. In the present example, the power source 70 is coupled to a back 72 of the head 18 and internal wiring carries the power upwardly toward the top end 48. In other examples, the power source 70 is a utility (e.g., residentially- or commercially-available electrical power). A user interface 74 is provided at the top end 48 for controlling power to the motor 40 and/or other components of the apparatus 10 described with respect to FIG. 4. It is appreciated that the location of the power source 70 and the user interface 74 can differ in other examples without deviating from the concepts of the present disclosure.

With continued reference to FIGS. 2 and 3, the coupling arrangement includes the sensor 30 configured to detect a condition of the coupler arrangement 22. In the present example, the sensor 30 detects a force, such as the pulling force, for removing the cover layer 12 from the surface 14. Due to a consistent motion profile (e.g., rise over run) of the head 18 and carriage 22, efficient and accurate readings can be gathered across multiple surfaces 14, and various target tensile strengths can be derived for comparison to the actual data gathered.

Referring now to FIG. 4, a communication circuit 76 can be provided for operating the apparatus 10. In some examples, the communication circuit 76 can be simpler or more complex than illustrated. In this example, a controller 78 is provided for processing data from sensing devices on the apparatus 10 and for controlling the motor 40. It is contemplated that the controller 78 can be omitted in some examples, with the motor 40 being directly controlled by the user interface 74.

The user interface 74 can incorporate any number of buttons or switches for controlling operation of the apparatus 10. For example, a toggle switch can be provided for turning power to the motor 40 off, driving the motor 40 clockwise, and driving the motor 40 counterclockwise. Any combination of lights for visually indicating operation of the apparatus 10 and speakers for audibly indicating operation of the apparatus 10 can also or alternatively be provided. In some examples, a display screen or a touch screen is provided for operating the apparatus 10.

The controller 78 can include a processor and a memory storing instructions that, when executed by the processor, cause the controller 78 to manage communications between devices on the communication circuit 76. The apparatus 10 may have access to a network 80 in some examples. For example, force data gathered by the sensor 30 can be stored in the memory or an external database or be streamed to remote devices (e.g., mobile devices, remote computers). For example, the controller 78 can be communicatively coupled with other wireless devices via Bluetooth®, Wi-Fi®, or any other wireless communication protocol. In this way, data can be recorded efficiently and stored for future reference. In some examples, the sensor 30 itself includes a processor and memory, such that the information is stored in the sensor 30.

With continued reference to FIG. 4, one or more limit switches 82 can be provided on either or both of the slide 20 or the head 18. The limit switches 82 can flag when the head 18 or the coupling assembly has moved fully forward/upward or backward/downward. The limit switches 82 can interrupt operation of the motor 40 until the limit switches 82 are no longer flagged. Consistent with the previously-described components of the communication circuit 76, the limit switches 82 can be omitted in some examples.

In operation, the motor 40 is actuated to drive the carriage 22 upwardly after the clamp 54 is clamped to the strip 28. As the carriage 22 moves upwardly, the strip 28 is peeled away from the surface 14 and the force to peel the strip 28 is measured. Concurrently, the upward movement of the carriage 22 causes the head 18 to pull forward due relative to the base 16 due to the mechanical connection with the base 16 via the pulley system 56. By sliding the head 18 while testing for the force to peel the strip 28, the tensile strength of the cover layer 12 can be accurately and continuously measured.

According to one aspect, an apparatus for testing adhesive strength between a cover layer and a surface includes a base, a head operably coupled with the base via a slide such that the head is configured to slide with respect to the base, a coupler assembly configured to attach to the cover layer, and an actuator configured to drive the coupler assembly vertically upward to separate the cover layer from the surface and to simultaneously slidably move the head along the slide.

According to another aspect, an apparatus for testing adhesive strength between a cover layer and a surface includes a base, a head operably coupled with the base via a slide, a coupler assembly configured to attach to the cover layer, an actuator disposed in the head configured to drive the coupler assembly upward to separate the cover layer from the surface and to move the head along the slide, and a pulley system between the base and the coupler assembly, wherein the pulley system is configured to move the head along the slide in response to the actuator driving the coupler upward.

According to yet another aspect, an apparatus for testing adhesive strength between a cover layer and a surface includes a base, a head slidably coupled with the base via a slide, a coupler assembly including a clamp configured to attach to the cover layer, and including a clamp, an actuator configured to drive the coupler assembly upward to separate the cover layer from the surface and to move the head along the slide, a pulley system between the base and the coupler assembly, wherein the pulley system is configured to pull the head along the slide in response to the actuator driving the coupler upward, and a sensor configured to measure a pulling force between the clamp and the cover layer as the head moves along the slide.

According to one aspect, the actuator includes a motor.

According to one aspect, a drive screw extending along a height of the head and operably coupled with the motor, wherein activation of the motor causes vertical movement of the coupler assembly via the drive screw.

According to one aspect, a sensor configured to measure a condition of the coupler assembly as the head moves along the slide.

According to one aspect, the condition of the coupler assembly is a pulling force between the coupler assembly and the cover layer.

According to one aspect, a pulley system between the base and the coupler assembly, wherein the pulley system is configured to slidably move the head along the slide in response to the actuator driving the coupler assembly vertically upward.

According to one aspect, the pulley system includes a pulley mounted to the head.

According to one aspect, the pulley system includes a cable engaging the pulley between the base and the coupler assembly.

According to one aspect, the cable has a fixed length between a first end secured to the base and a second end secured to the coupler assembly.

According to another aspect, the slide includes a rail mounted to the base and a glide coupled to and configured to slidably move along the rail.

According to one aspect, the actuator is disposed within the head.

According to one aspect, the apparatus is configured to test the adhesion strength between the cover layer and the surface without being secured to the surface.

According to one aspect, the actuator includes a motor.

According to one aspect, a drive screw extending along a height of the head and operably coupled with the motor, wherein activation of the motor causes the vertical movement of the coupler assembly via the drive screw.

According to one aspect, a sensor configured to measure a condition of the coupler assembly as the head moves along the slide.

According to one aspect, the condition of the coupler assembly is a pulling force between a clamp of the coupler assembly and the cover layer.

According to one aspect, the pulley system includes a pulley mounted to the head and a cable engaging the pulley between the base and the coupler assembly.

According to yet another aspect, the cable has a fixed length between a first end on the base and a second end on the coupler assembly.

According to one aspect, the slide includes a rail mounted to the base and a glide coupled to and configured to move along the rail.

According to one aspect, the actuator is disposed within the head.

According to one aspect, the apparatus is configured to test the adhesion strength between the cover layer and the surface without being secured to the surface.

According to one aspect, the apparatus includes a pulley system between the base and the coupler assembly, wherein the pulley system is configured to pull the head along the slide in response to the actuator driving the coupler upward.

According to one aspect, the pulley system includes a pulley mounted to the head and a cable engaging the pulley between the base and the coupler assembly.

According to one aspect, the head extends substantially orthogonal relative to the base.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An apparatus for testing adhesive strength between a cover layer and a surface, comprising:
a base;
a head operably coupled with the base via a slide such that the head is configured to slide with respect to the base;
a coupler assembly configured to attach to the cover layer;
an actuator configured to drive the coupler assembly vertically upward to separate the cover layer from the surface and to simultaneously slidably move the head along the slide; and
a sensor operably coupled to the coupler assembly and configured to measure a condition of the coupler assembly as the head moves along the slide.

2. The apparatus of claim 1, wherein the actuator includes a motor.

3. The apparatus of claim 2, further comprising:
a drive screw extending along a height of the head and operably coupled with the motor, wherein activation of the motor causes vertical movement of the coupler assembly via the drive screw.

4. The apparatus of claim 1, wherein the condition of the coupler assembly is a pulling force between the coupler assembly and the cover layer.

5. The apparatus of claim 1, further comprising:
a pulley system between the base and the coupler assembly, wherein the pulley system is configured to slidably move the head along the slide in response to the actuator driving the coupler assembly vertically upward.

6. The apparatus of claim 5, wherein the pulley system includes a pulley mounted to the head.

7. The apparatus of claim 6, wherein the pulley system includes a cable engaging the pulley between the base and the coupler assembly.

8. The apparatus of claim 7, wherein the cable has a fixed length between a first end secured to the base and a second end secured to the coupler assembly.

9. The apparatus of claim 1, wherein the slide includes a rail mounted to the base and a glide coupled to and configured to slidably move along the rail.

10. The apparatus of claim 1, wherein the actuator is disposed within the head.

11. The apparatus of claim 1, wherein the apparatus is configured to test the adhesion strength between the cover layer and the surface without being secured to the surface.

12. An apparatus for testing adhesive strength between a cover layer and a surface, comprising:
a base;
a head operably coupled with the base via a slide;
a coupler assembly configured to attach to the cover layer;
an actuator disposed in the head configured to drive the coupler assembly upward to separate the cover layer from the surface and to move the head along the slide;
a pulley system between the base and the coupler assembly, wherein the pulley system is configured to move the head along the slide in response to the actuator driving the coupler upward; and
a sensor operably coupled to the coupler assembly and configured to measure a condition of the coupler assembly as the head moves along the slide.

13. The apparatus of claim 12, wherein the actuator includes a motor.

14. The apparatus of claim 13, further comprising:
a drive screw extending along a height of the head and operably coupled with the motor, wherein activation of the motor causes the vertical movement of the coupler assembly via the drive screw.

15. The apparatus of claim 12, wherein the condition of the coupler assembly is a pulling force between a clamp of the coupler assembly and the cover layer.

16. The apparatus of claim 12, wherein the pulley system includes a pulley mounted to the head and a cable engaging the pulley between the base and the coupler assembly.

17. The apparatus of claim 16, wherein the cable has a fixed length between a first end on the base and a second end on the coupler assembly.

18. The apparatus of claim 12, wherein the slide includes a rail mounted to the base and a glide coupled to and configured to move along the rail.

19. The apparatus of claim 12, wherein the actuator is disposed within the head.

20. The apparatus of claim 12, wherein the apparatus is configured to test the adhesion strength between the cover layer and the surface without being secured to the surface.

21. An apparatus for testing adhesive strength between a cover layer and a surface, comprising:
a base;
a head slidably coupled with the base via a slide;
a coupler assembly including a clamp configured to attach to the cover layer and including a clamp;
an actuator configured to drive the coupler assembly upward to separate the cover layer from the surface and to move the head along the slide;
a pulley system between the base and the coupler assembly, wherein the pulley system is configured to pull the head along the slide in response to the actuator driving the coupler upward; and
a sensor configured to measure a pulling force between the clamp and the cover layer as the head moves along the slide.

22. The apparatus of claim 21, further comprising:
a pulley system between the base and the coupler assembly, wherein the pulley system is configured to pull the head along the slide in response to the actuator driving the coupler upward.

23. The apparatus of claim 21, wherein the pulley system includes a pulley mounted to the head and a cable engaging the pulley between the base and the coupler assembly.

24. The apparatus of claim 21, wherein the head extends substantially orthogonal relative to the base.
